(19) United States
(12) Patent Application Publication
(10) Pub. No.: US 2006/0117388 A1
(43) Pub. Date: Jun. 1, 2006

(54) System and method for modeling information security risk

(76) Inventors: Catherine Blackadar Nelson, Santa Cruz, CA (US); Rakesh Chandrakant Bharania, San Jose, CA (US)

Correspondence Address: WAGNER, MURABITO & HAO, LLP, TWO NORTH MARKET STREET, THIRD FLOOR, SAN JOSE, CA, 95113, US

(21) Appl. No.: 10/993,633

(22) Filed: Nov. 18, 2004

(51) Int. Cl. G06F 11/00; G06F 11/22; G06F 11/30; G06F 11/32; G06F 11/34; G06F 11/36; G06F 12/14; G06F 12/16; G06F 15/18; G08B 23/00

(52) U.S. Cl. 726/25

(57) ABSTRACT

A system and method for modeling information security risk to an enterprise are disclosed. The method includes providing multiple input media, each of which forms a vector of risk severity in a dimension characterizing the information security risk. Each vector is of a dimension distinct from that of each other vector. The input media are user interactive for providing input to a computer in a network environment. The input includes data corresponding to the magnitude and dimension of each of the vectors. Upon receiving the input, the vectors are processed to output a model of the information security risk. Each risk can be modeled from the perspective of at least two dimensions, one related to a technical exploitation aspect of the risk, and the other related to a risk aspect associated with business impact. The input media can be a web based application.

### TECHNICAL FIELD

The present invention relates generally to the field of information security. More specifically, embodiments of the present invention relate to a method and system for modeling real-world information security risk.

### BACKGROUND

Modern enterprises engage in many activities wherein information is exchanged by networked computer systems, which efficiently access, transmit, route, receive, and process data to effectively achieve such information exchange. Exchange of information between networked computers allows productive network based interaction and transactions, such as remote access to useful data between a client computer and a server. Useful information technology functions can thus be achieved, including file sharing, web based applications, and a growing host of other convenient and important capabilities.

Modern networked computer environments however can be subject to various threats that can compromise sensitive data and/or attack the network and computer platforms. Compromise of sensitive data and exploitation of vulnerabilities of data exchange platforms can be costly and harmful for any enterprise. In the face of these threats to data and platforms, which have become persistent to some enterprises, and which, in fact can seem to evolve and become more pernicious, providing information security in a networked computer environment has become a concern of heightened priority.

Various information security techniques are practiced, such as considering the degree of risk to which an enterprise is exposed by an information technology project confronted by various threats. For instance, where a new information technology project is undertaken, an enterprise may attempt to determine an information security risk that may be associated with that project, e.g., inherent therewith. Conventionally, information security risks are considered using either site based methods or system based methods, which are typically quite comprehensive in nature.

Conventional site based risk determination methods attempt to assess a level of risk to information security from the perspective of the particular enterprise, for example, of a particular facility, business unit or organization, etc. Site based risk assessment is typified by methods substantially compliant with the ISO 17799 (International Standards Organization for Standardization, Geneva, Switzerland) Standard and the British Standard BS 7799, and hybrids thereof, although other site based methods are practiced as well.

Conventional system based risk determination methods attempt to assess the level of risk posed to information security from the perspective of the relevant technology characterizing the enterprise activity, of its infrastructure (e.g., networking, computing), etc. Site based and system based risk assessment tools are available commercially.

However, conventional comprehensive risk assessment methods can be resource and time intensive. For instance, one conventional risk assessment method uses over 240 questions, the responses of which provide input thereto, and typically renders an assessment after delays of up to four to six months. Assessments from others can also take months. The complexity characterizing these assessment methods contributes to such delays.

Some users may also find that assessment questions of some such conventional methods can be somewhat vague for their particular needs, seem based on a single and/or particular point of view, and may be based on untested, perhaps irrelevant assumptions. Various conventional methods may be based on assumptions and/or viewpoints quite different from each other.

This disparity in viewpoint and assumptions seems due in part to how new the field of information security is, the rapidity with which it is developing, recent developments in various related technical and industry standards and active ad hoc non-standard based development. Such threats can come from ever-changing sources, using evolving and/or revolutionary techniques. The dynamic nature of the threats to which information is exposed also seems to contribute to such disparity. Such disparity can introduce a measure of subjectivity into a conventional risk modeling system.

For instance, two typical, perhaps similarly situated users, responding to the same assessment input questions, may provide different answers (e.g., for apparently subjective reasons). Such differing user experiences can lead to respective expectations that can tend to corrupt analytical judgment based thereon.

Further, users of a conventional risk modeling system, specializing in information security, may lack certain insight relating to relative importance, significance, value, etc. of particular information to an enterprise. These users may thus lack a degree of ability or effectiveness in evaluating various particular information technology projects with that system. For instance, the conventional risk management system may lack effectiveness in allocating finite security resources, can require inordinate time and/or resources to make evaluations and/or to justify a risk assumption scenario, and may provide guidance that is of limited or restricted value to enterprise executives and/or other decision makers.

### SUMMARY

What is needed is an ability to model information security risk associated with an enterprise that is economical in use of resources and time. What is also needed is an ability to model information security risk associated with an enterprise that is relevant, clear, and based on objective criteria. Further, what is needed is an ability to model information security risk associated with an enterprise that provides insight relating to the risk from more than one aspect, and which provides effective guidance for allocating security resources and justifying the assumption or avoidance of that risk.

A system and method for modeling information security risk to an enterprise are disclosed. The system and method use resources and time economically and are relevant, clear, and objectively based. This system and method provides insight relating to the risk from multiple aspects and can provide effective guidance for allocating security resources and justifying the assumption or avoidance of the risk.

The method includes providing multiple input media, each of which forms a vector of risk severity in a dimension characterizing the information security risk. Each vector is of a dimension distinct from that of each other vector. The input media are user interactive for providing input to a computer in a network environment. The input includes data corresponding to the magnitude and dimension of each of the vectors. Upon receiving the input, the vectors are processed to output a model of the information security risk. Each risk can be modeled from the perspective of at least two dimensions, one related to a technical aspect of the risk, and the other related to the business risk aspect associated with the enterprise. The input media can be a web based application.

### BRIEF DESCRIPTION OF THE DRAWINGS

FIG. 1 depicts an exemplary network based infrastructure, upon which an embodiment of the present invention can be practiced.

FIG. 2 depicts an exemplary network based application, upon which an embodiment of the present invention can be practiced.

FIG. 3 depicts an exemplary network based system for modeling a real-world information security risk, according to an embodiment of the present invention.

FIG. 4 depicts an exemplary project creation module, according to an embodiment of the present invention.

FIG. 5 depicts a screen shot of an exemplary graphical user interface (GUI) window for creating a risk modeling project, according to an embodiment of the present invention.

FIG. 6 depicts an exemplary questionnaire module, according to an embodiment of the present invention.

FIG. 7 depicts a screen shot of an exemplary GUI window for providing an information security based input to a risk model, according to an embodiment of the present invention.

FIG. 8 depicts an exemplary assessment module, according to an embodiment of the present invention.

FIG. 9 depicts an exemplary query and reporting module, according to an embodiment of the present invention.

FIG. 10 depicts an exemplary administrative module, according to an embodiment of the present invention.

FIG. 11 depicts an exemplary test module, according to an embodiment of the present invention.

FIG. 12 is a flowchart of an exemplary computer implemented process for modeling a real-world information security risk, according to an embodiment of the present invention.

### DETAILED DESCRIPTION

A system and method for modeling information security risk for an enterprise are disclosed. Reference is now made in detail to several embodiments of the invention, examples of which are illustrated in the accompanying drawing figures. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, one of ordinary skill in the art will realize that embodiments of the present invention may be practiced without these specific details. In other instances, well-known network environments, processes, systems, methods, processes, procedures, media, devices, circuits, components, and apparatus have not been described in detail so as not to unnecessarily obscure aspects of the present invention.

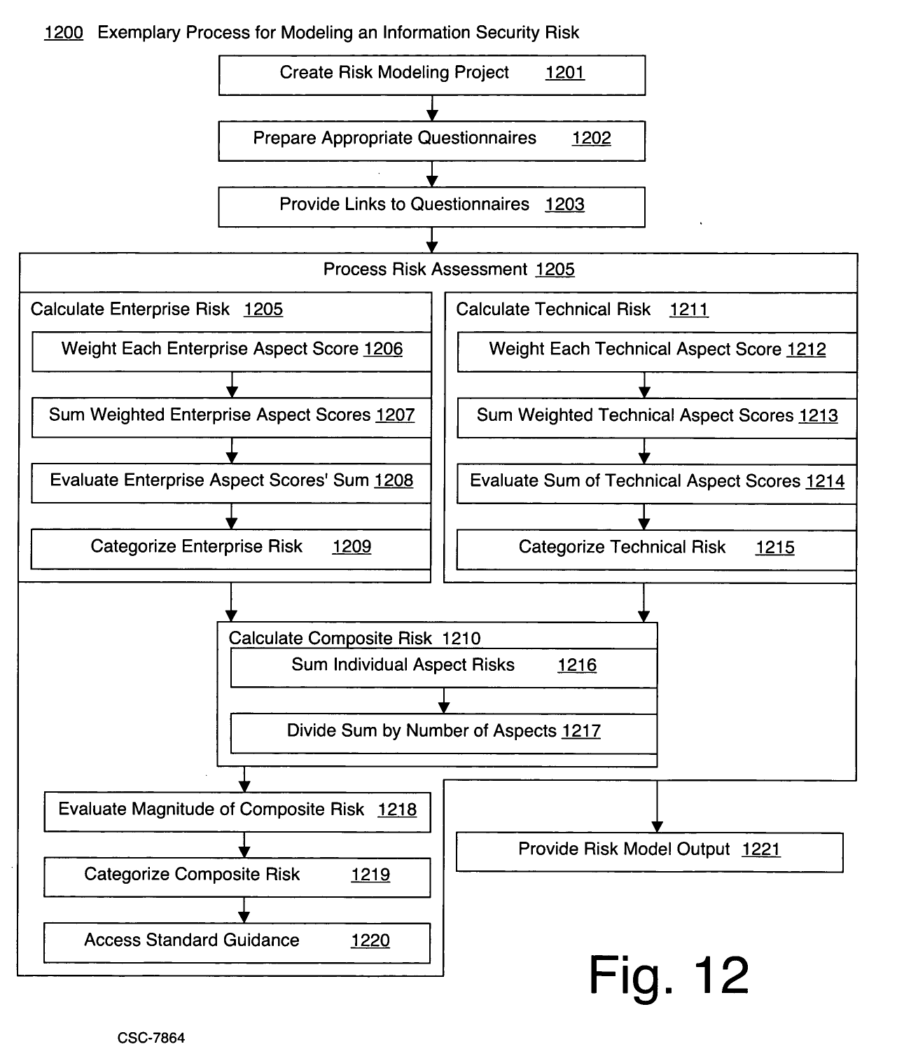

Portions of the detailed description that follows are presented and discussed in terms of a process. Although steps and sequencing thereof are disclosed in figures herein (e.g., FIG. 12) describing the operations of these processes (e.g., process 1200), such steps and sequencing are exemplary. Embodiments of the present invention are well suited to performing various other steps or variations of the steps recited in the flowcharts of the figures herein, and in a sequence other than that depicted and described herein. In one embodiment, such processes are carried out by processors and electrical and electronic components under the control of computer readable and computer executable instructions comprising code contained in a computer usable medium.

Embodiments of the present invention provide a system and method for modeling information security risk to an enterprise. In one embodiment, the method includes providing multiple input media, each of which forms a vector of risk severity in a dimension characterizing the information security risk. Each vector is of a dimension distinct from that of each other vector. The input media are user interactive for providing input to a computer in a network environment. The input includes data corresponding to the magnitude and dimension of each of the vectors. Upon receiving the input, the vectors are processed to output a model of the information security risk. In one embodiment, each risk is modeled from the perspective of at least two dimensions, one related to a technical aspect of the risk, and the other related to the business risk aspect associated with the enterprise. In one embodiment, the input media comprises a web based application.

Therefore, the time and resource expenditures, the vagueness, lack of clarity, and subjectivity that typically characterize conventional information risk modeling is avoided. Insight relating to information security risk is provided from the perspective of multiple aspects relating to an enterprise, which allows effective guidance for allocating security resources and justifying the assumption or avoidance of that risk. Further, the multi-vector approach to risk modeling characterizing the systems and methods disclosed herein is simple and powerful. The embodiments described herein are uniquely very simple to use and provide guidance, based on risk level. The multidimensional vectored approach described herein is uniquely powerful in its ability to balance out all aspects of concern relating to security, rather than a single risk aspect. Such balancing explains the risk levels and what they mean in relationship to each other. Corresponding user guidance is provided, based on the risk level a modeled project falls into. Unlike conventional approaches, the systems and methods described herein do not try and predict how likely something is to be attacked. Instead, the systems and methods described herein give the likelihood that an attack will succeed if attacked.

Exemplary Infrastructure

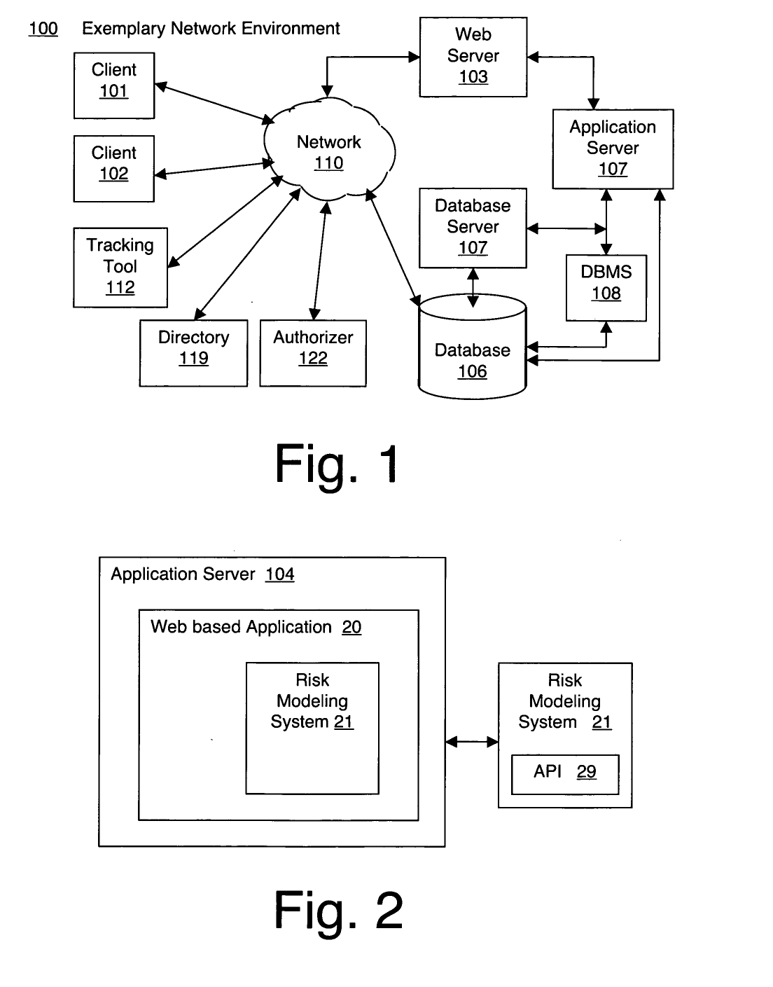

FIG. 1 depicts an exemplary network based infrastructure 100, upon which an embodiment of the present invention can be practiced. Infrastructure 100 can be based on any capable network. In one embodiment, infrastructure 100 comprises a web based environment in which network 110 comprises, e.g., an intranet, the Internet, etc.

Client computers 101 and 102 access other components of infrastructure 100 via network 110. There is no particular limit to the number of client computers supportable by infrastructure 100 relevant to the discussion of the present invention. Infrastructure 100 has a web server 103, which has access to network 110, an application server 104, and a database server 107.

The web environment of infrastructure 100 can be UNIX based, Windows based, or another operating system. The web environment can also be enterprise (e.g., organization, business, etc.) based and exclusively accessible internally to the enterprise. In the exemplary embodiments discussed herein, the web environment characterizing infrastructure 100 runs substantially Java based programs. In other embodiments, the web environment characterizing infrastructure 100 runs programs based on Java, Practical Extraction and Reporting Language (PERL), Personal homepage Hypertext Preprocessor (PHP) language, and/or C, etc. The web environment characterizing infrastructure 100 features including load balancing, failover, and built-in redundancy.

One exemplary implementation of infrastructure 100 provides a Java based web environment wherein web server 103 depicts one or more Apache™ or similar web servers, application server 104 depicts one or more Borland™ Enterprise Servers or similar application servers, database server 107 depicts one or more Oracle™ or similar database servers. Where multiple application servers are depicted by application server 104 (and e.g., multiple web servers by web server 103), each application server links to the various web servers and provides load balancing and other fault tolerance for high volume traffic (e.g., failover, built-in redundancy, etc.).

Applications running in the web environment of this implementation are compliant with the Java 2 Platform, Enterprise Edition™ (J2EE) and run in their own Java Virtual Machine (JVM). It should be appreciated that the web environment of infrastructure 100 can be implemented with various other configurations, features, and/or components, etc.

In one embodiment, application server 104 accesses network 110 via web server 103. Alternatively, application server 14 has direct access to network 110. In one embodiment, application server 104 accesses a database 106 via database server 107, using a database management system (DBMS) 108. Application server 104 processes information for client computers 101 and 102 and provides processing required to provide the client computers with current information. In one embodiment, application server 104 performs business logic, which functions with DBMS 108.

In the present implementation, Common Gateway Interface (CGI) scripts are supported and processing is performed with Enterprise JavaBeans (EJB), Java Server Pages (JSP), and/or Java servlets. Another linkage modality between the content of database 106 and particular Hypertext markup Language (HTML) documents (e.g., web pages, etc.) can be supported with the CGI scripts.

In one exemplary implementation of infrastructure 100, database 106 depicts one or more databases. Database server 107 includes DBMS 108 and accesses database 106 for storing and retrieval of information therein. DBMS 108 controls organization, storage, retrieval, security, and integrity of the information in database 106.

Web server 103 provides web functionality within infrastructure 100 with its hardware and operating system (OS), with software, with Transfer Control Protocol/Internet Protocol (TCP/IP) and content such as web pages and other documents, e.g., rendered in HTML. Where infrastructure 100 comprises an internal, enterprise based network infrastructure, network 110 comprises an intranet and web server 103 functions as an intranet server.

Web server 103 handles information requests in, Hypertext Transfer Protocol (HTTP) and responds with appropriate HTML documents. Web server 103 also executes, CGI scripts, JSPs, and Active Server Pages (ASP), etc. In one exemplary implementation, web server 103 comprises a separate HTTP server, File Transfer Protocol (FTP) server, and/or Simple Mail Transfer Protocol (STMP), etc. In another, web server 103 provides all such functionality in a single entity.

In one embodiment, web server 103 uses a Lightweight Directory Access Protocol (LDAP) to access a directory 119 and includes an Application Program Interface (API) 121 to pull information from directory 119 into database 106. In one embodiment, an LDAP based (or another) authentication functionality (e.g., authenticator) 122 operates with an API 121 to manage authentication and authorization checking for users attempting to access information in directory 119 and/or database 106. Applications (e.g., network based application 119) use standard LDAP calls to communicate with authenticator 122, API 121, etc.

In one embodiment, application server 104 provides middleware functionality to enable a browser based application to access various information sources. Application server 104 supports a suite 109 of network based applications, which in one embodiment can be web based. Network based applications of suite 109 are initiated from client computers 101 and/or 102 and served from application server 14 via network 110 with web server 103.

Infrastructure 100 has a tracking tool 112 or another tracking functionality. Tracking tool 112 assigns a unique identifier to projects running on applications of suite 109.

FIG. 2 depicts an exemplary web based application 20, upon which an embodiment of the present invention can be practiced. In one exemplary implementation, web based application 20 comprises an application of application suite 109 (FIG. 1). In this implementation, web based application 20 is run from a client computer by a user and provides functionality for modeling information security risk according to an embodiment of the present invention.

In one embodiment, the functionality of web based application for modeling information security risk is provided with a modular system, which can be implemented in software, hardware, firmware and/or any combination of same. Such software comprises, in one embodiment, a computer readable medium having encoded therein (e.g., thereon, etc.) a code for causing a computer system to perform a method for modeling information security risk.

In one embodiment, the modules comprising the system for modeling information security risk are components of web based application 21 and the application functions as an information security risk modeling tool. In another embodiment, various such modules are accessed with web based application 21, which effectively functions as a software bus, hub, etc. for the system for modeling information security risk. In one embodiment, web based application 21 has an API 29 to allow other, authorized applications, to provide application 21 with queries relating to its informational risk modeling tool functionality.

Exemplary System

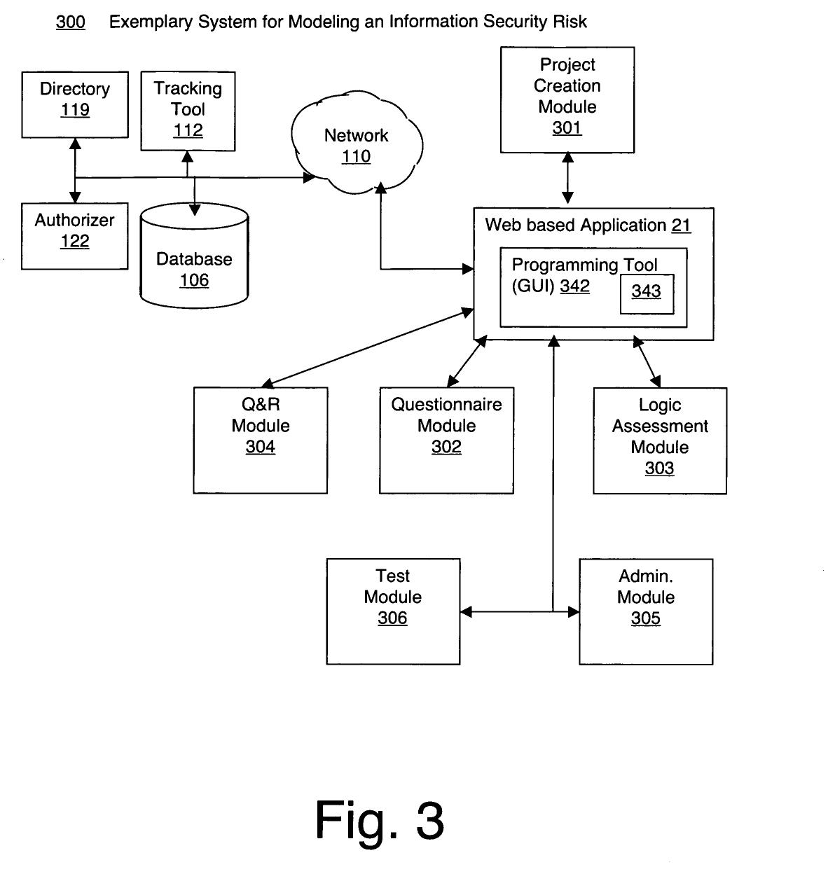

FIG. 3 depicts an exemplary network and computer based system 300 for modeling real-world information security risk, according to an embodiment of the present invention. Modules comprising system 300 are coupled (e.g., interconnected, conjoined, and/or co-functional, etc.) to one another with web based application 21. In another embodiment, the modules of system 300 comprise components of web based application 21 and are coupled e.g., via a software bus. Web based application 21 has access to network 110 (e.g., in one embodiment via web server 103; FIG. 1).

System 300 has a project creation module 301, which provides functionality for creating (e.g., establishing, opening, e.g., as a designated file, etc.) a new information security risk modeling project. Project creation module 301 allows a project creating user to name the project and to identify at least two users (e.g., one of whom can be the project creating user) who will provide input to system 300.

Each such input providing user provides information relating to a unique aspect of the security risk modeling project according to a unique assigned role, such as a personal and/or enterprise related expertise and/or insight function relevant to the security risk modeling project. In one embodiment, at least one user provides an input relating to a technical aspect of information security risk associated with the project and at least one other user provides an enterprise (e.g., business) related input. The technical aspect relates, in one embodiment, to the ease with which a particular technology, characterizing e.g., an information technology (IT) project, service, etc., can be exploited (e.g., compromised, used against the interests of the enterprise, etc.).

In one embodiment of the present invention, system 300 accesses information provided by effectively cognizant and/or responsible shareholders in the project, at least one having cognizance and/or responsibility for the technical aspect and at least one having cognizance and/or responsibility for the business aspect. The present embodiment can also be implemented with input relating to one or more other aspects. The present embodiment thus considers an information security risk from a number different dimensions. Scoring the information input, such as weighting a series of answers provided in an interactive set of questions (e.g., a questionnaire) or another input allowing modality relating to that aspect, provides a magnitude of risk in that particular dimension, which can be combined to calculate a composite information security risk. The present embodiment therefore provides a multi-vectored approach to modeling information security risk, the input in each individual aspect comprising a separate vector.

Each of the input providing users can be identified, e.g., by an email address, which system 300 can use to contact the users with links (e.g., hyperlinks relating to the newly created risk modeling project),

Project creation module 301 functions with tracking tool 112 to provide the new information security risk modeling project with a unique identifier, e.g., a unique identity number. The unique identifier accesses the security risk modeling project, information relating to the project, etc. In one embodiment, such access is provided with a link (e.g., a hyperlink) to the project. In another embodiment, tracking tool 112 provides additional information relating to the security risk modeling project, for instance with an API.

A questionnaire module 302 provides a unique functional set of questions (e.g., questionnaire) to each input providing user according specifically to their role. The questionnaire web application allow user input in the form of responses to a variety of questions relevant to the risk modeling project. One such questionnaire is unique to the technical aspects of the risk modeling project. Another is unique to the business aspects thereof.

In one embodiment, the questionnaires comprise interactive web pages, web applications, etc. In one such embodiment, a computer controlled programming tool 342 having a graphical user interface (GUI) or another interface is provided, e.g., with web based application 21, and functions, e.g., with client computers 111 and 112 (FIG. 1), to allow the users to provide their inputs with their respective questionnaires, e.g., with clickable choice boxes, text input fields, menus, etc. Questionnaire module 302 provides search capability to the users.

In one embodiment, completion (e.g., and submission) of their set of questions (e.g., questionnaire) by either user automatically results in notification of the other user(s) as to this fact, e.g., via email. Upon completion of all related questionnaires, logic assessment relating to modeling (e.g., considering, calculating, etc.) the security risk is invoked.

Logic assessment related to modeling the security risk is provided with logic assessment module 303 and allows associated risk analysis to be run (e.g., performed, executed, etc.). Logic assessment module 303 accesses information provided by the inputting users via the questionnaires, handles their respective inputs to determine risks factors unique to each, combines the respective such risk factors, and calculates a corresponding combined information security risk, with which the risk is modeled according to a computer implemented process.

Logic assessment module 303 provides an output that can be viewed on monitors used with (e.g., comprising components of) client computers 111, 112, etc., consoles, workstations, etc. associated with various servers (e.g., web server 103, application server 104; FIG. 1), and various other computers associated with system 300 and/or infrastructure 100 (FIG. 1). The output of logic assessment module 303 is also provided to database 106. Logic assessment module 303 provides search capability to its users.

In one embodiment, a query and reporting module 304 provides guidance functionality to users of system 300. Such guidance can take the form of standard advice based on categorization of the risk model generated by the project and the output (e.g., risk modeling results) of logic assessment module 303. In another embodiment, logic assessment module 303 (or another module of system 300) provides the guidance function. The output comprises a composite risk score (Rc), two individual risk scores (Technical exploit risk R1 and risk to business R2), a risk category (Severe, High, Moderate, Intermediate, Low, respectively), and pre-stored guidance relating to that risk category.

A system administration module 305 allows changes, such as add, modify, delete, etc., to be made to various existing (e.g., in-progress, on-going, paused, postponed, ready, etc.) risk modeling projects stored in database 106. Such changes can be made in relation to input-providing user identities, authorizations, roles, etc., as well as users authorized to make administrative changes to the projects (e.g., administrative users).

Administrative changes can comprise modification of questionnaires, including their questions and category related guidance. Variables used in algorithms, which can direct various related computer implemented processes, can also be modified. Such variables, each questionnaire, a guidance list for each category, and the category names (e.g., aspects authorized, etc.), all configurable by administration module 307, are stored in database 106.

A test module 306 allows use of system 300 as a fast risk model prototyping tool that can be used and re-used. Test module 306 provides an efficient, inexpensive, platform for estimation, experimentation, etc. that is not heavily dependent on processing, networking, and database resources. A single user (e.g., an input providing user with a role related to the technical aspects of risk modeling, such as an information security specialist, expert, engineer, etc.) answers all (e.g., both technical aspect and business aspect) questionnaires using test module 306 and runs (e.g., repeatedly if/as desired) a rapid risk model prototype. In the rapid prototype, logic assessment module 303 provides effectively immediate assessment, based on the test questionnaires' input, to an associated monitor, without writing results to database 106.

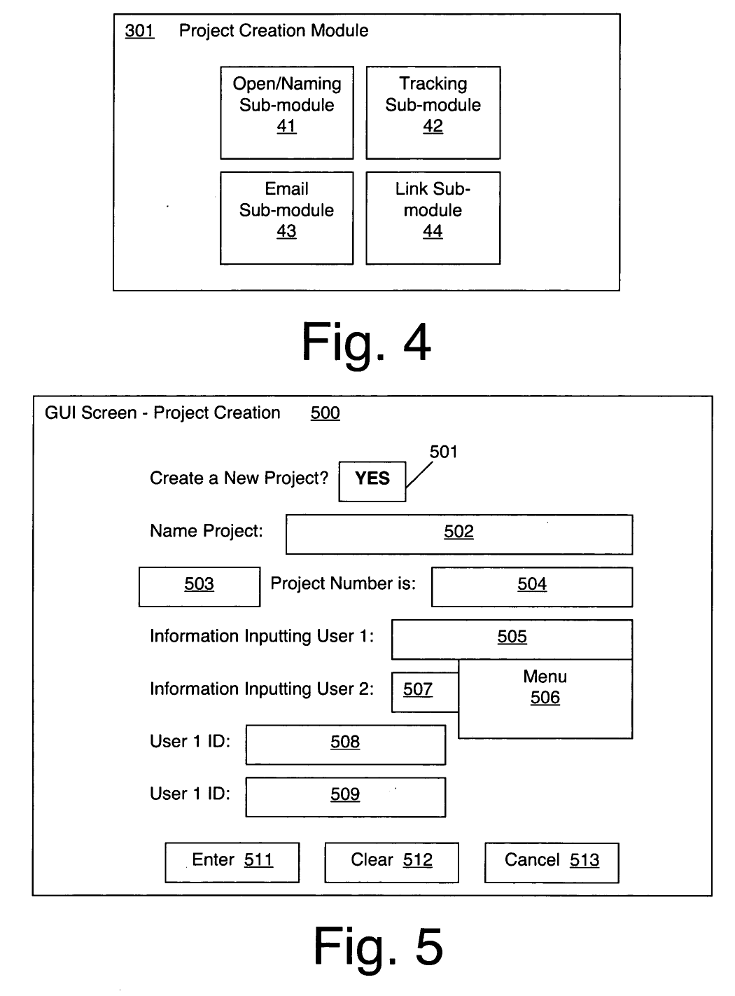

FIG. 4 depicts an exemplary project creation module 301, according to an embodiment of the present invention. Project creation module as a project opening and naming component 41, which allows a user (e.g., an administrative user) of module 301 to open and name, e.g., a file corresponding to a new risk modeling project.

A tracking component 42 allows module 301 to access tracking functionality 112 for assigning an identifier to the project, which is unique within infrastructure 100 (FIG. 1). An email component 43 emails (e.g., or otherwise contacts) designated input providing users and provides a link such as a hyperlink to an HTML based or other document that is generated by a linking component 44.

In one embodiment, module 301 provides to a user an interactive web page or another interactive medium. In one such embodiment, a GUI provided e.g., with web based application 21 (FIG. 2, 3) allows the user to provide project creating input to name and have assigned (e.g., or assign) a unique identifier such as a project number. The web page and GUI also allow the user to designate, e.g., by name and/or email address, two (or more) input providing users, to whom questionnaires, one technology based and the other business related, will be sent upon entering the input. In one embodiment, when the project creating information is entered, links to the questionnaires are emailed to the designated input providing users. In one embodiment, directory 119 and/or authorizer 122 provide related email and other functionality, which can be LDAP based.

FIG. 5 depicts a screen shot of an exemplary graphical user interface (GUI) window 500 for creating a risk modeling project, according to an embodiment of the present invention. Creating a risk modeling project comprises, in one embodiment, interactively opening and designating a file in a web application wherein an information security risk model is applied to inputs relating to a corresponding enterprise activity, such as an IT service, project, etc. For instance, clicking interactive screen button 501 with the GUI allows a user to cause system 300 to open and designate a file in web application 21 (FIG. 3).

Upon creating the new project, the user types a name for the project in text field 502. Upon entering the project name, that name (or e.g., an automatically generated abbreviation thereof) can appear in space (e.g., non-interactive text and/or graphics display field) 503, and a unique identifier, such as a unique project number, is assigned by tracking tool 112 (FIG. 1), and displayed in space 504. In one embodiment, an API or another functionality allow other information relevant to the project to be pulled from the tracking tool 112.

Text field 505 allows the project creating user to enter the name or another designator, identifier, address, etc. (e.g., employee number, title, email address, etc.) to designate a first input providing user. In one embodiment, a pop-up, drop-down, or other menu 506 can appear from which a scrollably highlightable and clickably selectable list of authorized, frequently assigned, specially qualified, and/or otherwise pre-designated first input providing users can be chosen.

Similarly, Text field 507 allows the project creating user to enter the name or another designator, identifier, address, etc. to designate a second input providing user. A menu such as depicted menu 506 can appear from which pre-designated second input providing users can be chosen. Upon designating the first and second input providing users, corresponding identifiers, such as email addresses, etc., can be displayed in spaces 508 and 509, respectively.

More than two input providing users may be designated in one embodiment, through additional or differently configured text fields and/or menus. In one embodiment, one of at least two users has an information input role based on technical aspects of the risk modeling project and the other has a role based on business or other enterprise related aspects thereof. Where more than two users are designated to provide information input, the roles of the others may relate to other aspects of the risk modeling project.

Screen buttons 511, 512, and 513 respectively allow the data provided by the creating user in fields 502, 505, and 507 to be entered, cleared, or cancelled. Other functional buttons and/or other features can be provided by interactive window 500.

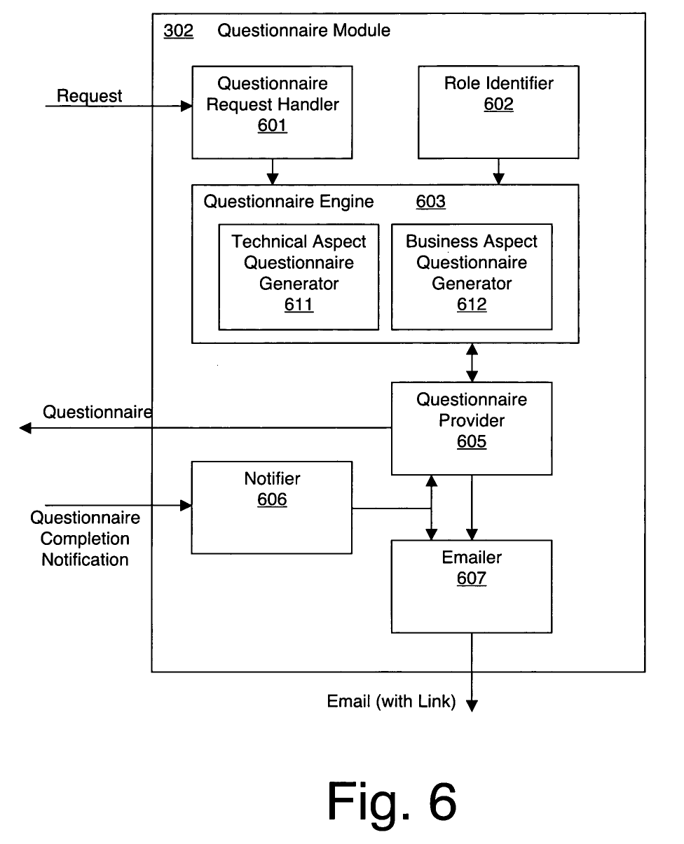

FIG. 6 depicts an exemplary questionnaire module 302, according to an embodiment of the present invention. Upon accessing a link such as clicking a hyperlink sent, e.g., with an email addressed to them, an input providing user (e.g., at client computer 111; FIG. 1) sends a questionnaire request via network 110 to system 300, which routes (or otherwise directs) the request to questionnaire module 301.

A questionnaire request handler 601 activates role identifier 602, which identifies the request as one for a technical aspect questionnaire or for a business aspect questionnaire, thus effectively ascertaining (e.g., inferring, determining, etc.) the role of the input providing user requesting the questionnaire. Role identifier 602 interprets the request and/or can respectively access authorization and/or directory data, e.g., from authorizer 122 and directory 119 (FIG. 1).

Upon determining whether a technical aspect questionnaire or a business aspect questionnaire request has been requested, role identifier 602 activates a questionnaire engine 603. Based on the identified role, the appropriate questionnaire, which in one embodiment comprises an HTML document such as an interactive web page, is generated by questionnaire generators 611 and 612, which respectively generate technical aspect and business aspect questionnaires. Questionnaire engine 603 can also provide a questionnaire related to another aspect relevant to the security risk modeling project, e.g., with another questionnaire generator associated with that aspect. In one embodiment, a single questionnaire generator generates questionnaires related to every relevant aspect of the project.

A generated questionnaire is sent to the requesting user by questionnaire provider 605 and can also be stored, cached, etc. Notification received that a provided questionnaire has been completed (e.g., submitted) by the input providing user is routed by system 300 to questionnaire module 301 is accessed by notifier 606. Upon receiving such notification, notifier 606 activates an email sender 607, and ensures, via questionnaire provider 605 that a questionnaire for the complimentary aspect (e.g., the technical aspect and the business aspect are complimentary) is available (e.g., and triggers same, if not).

Email sender 607 then sends an email to notify the second input providing user that the completed complimentary questionnaire has been submitted by a first input providing user. The email has a link to a questionnaire to be completed by the second input providing user. In an exemplary implementation, the input providing user designated to provide input from a technical perspective, is notified (e.g., via email) when the input providing user designated to provide input from a business/enterprise perspective does so.

In the present implementation, where the business/enterprise related questionnaire has been submitted at the time the user designated to provide input from a technical perspective responds to (e.g., completes, fills out, etc.) their questionnaire, the technical input providing user is so notified and an option is provided for generating the security risk model, e.g., running the risk assessment, upon committing to the responses of that technical questionnaire. In one embodiment, this invokes logic assessment, e.g., logic assessment module 303 (FIG. 3,).

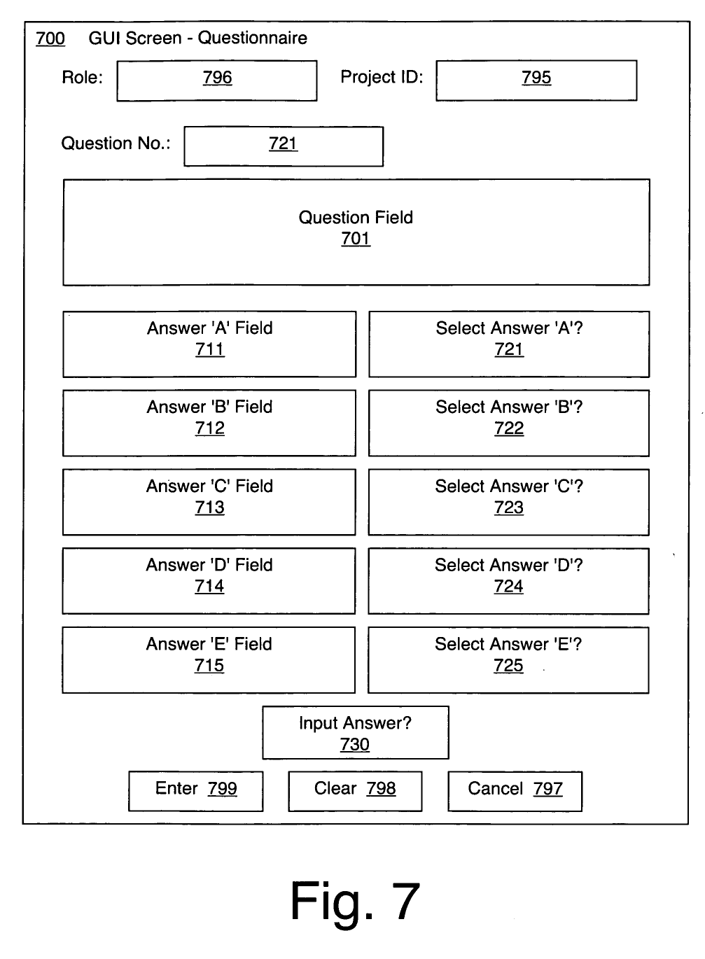

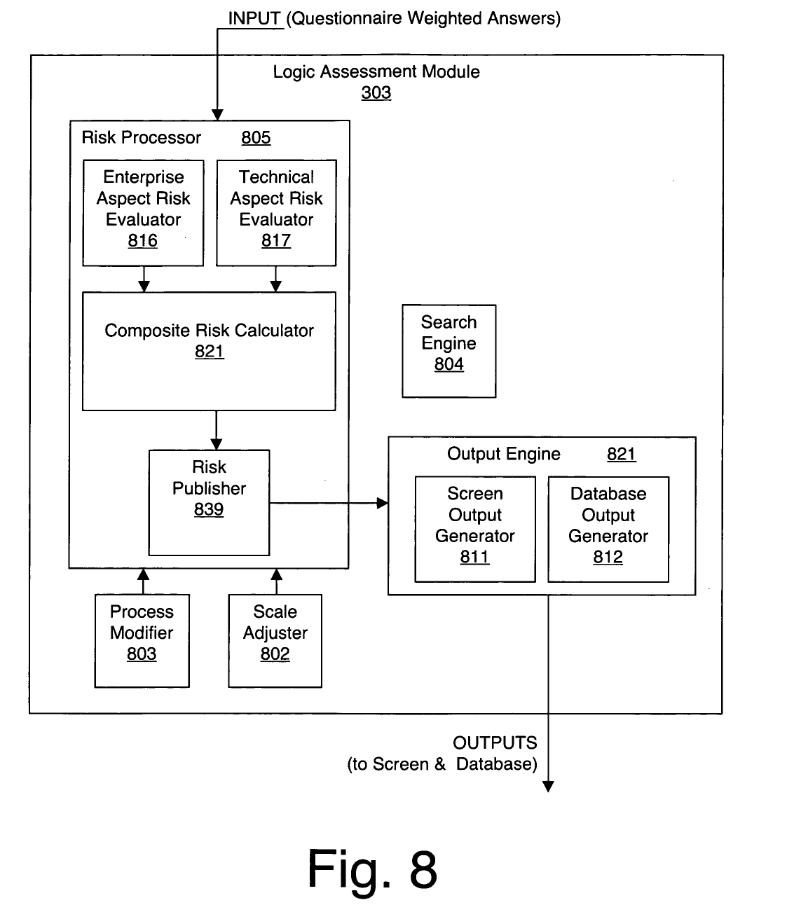

FIG. 7 depicts a screen shot of an exemplary GUI window 700 for providing an information security based input to a risk model, according to an embodiment of the present invention. In one embodiment, GUI window 700 displays a questionnaire page to an input providing user. Window 700 identifies the project to the user, e.g., with its unique identifier and/or project name, in space 795 and designates the user's assigned (e.g., identified) role in space 721.

In question field 701, a non-interactive text display space, one of a number of questions, designated by a question number or similar identifier in space 721, is displayed to the input providing user, e.g., for that user's consideration. In one embodiment, as few as ten role-appropriate (e.g., role relevant) questions are sequentially presented to the input providing user with a progressing sequence of changing questions presented in question field 701 of window 700. In another embodiment, the questions are sequentially presented to the input providing user with a progressing sequence of changing windows exemplified with window 700. Questionnaires are provided that are appropriate for a technical aspects role and for an enterprise, business, etc. aspects role. Questionnaires appropriate to other roles can also be provided.

In the present implementation, the GUI renders each question of each questionnaire separately, e.g., on its own unique HTML based interactive questionnaire page 700. In other implementations, the questions and/or questionnaires can be presented by an alternative presentation mode.

Within an interactive answer field 702, an array of possible answers to the question (e.g., as presented in field 701) is presented to the input providing user in non-interactive text display space fields 711-715. Answer choice screen buttons 721-725 respectively corresponding to each of fields 711-715 to allow the input providing user to select one of them. The selected answer is inputted to system 300 by clicking answer input screen button 730.

Answer choice screen buttons 721-725 are individually selectable to the exclusion of the other answer choices and can provide graphical indication such as lighting, shading, highlighting, etc. as to their respective selection (e.g., interactive activation). However, until the selected answer input is submitted, the selected answer can be changed by clicking another of answer choice screen buttons 721-725, which deactivates the initially selected answer choice screen button and activates that associated with the newly selected answer, which than provides indication as to its selection.

The questionnaires are interactively presented to their respective input providing users with a GUI and a monitor screen. The input providing users can each access their respective questionnaires from their own computer, the same computer, or any other computer with access to the network 110. For instance, the technical aspect input providing user can the corresponding questionnaire on a monitor associated with client computer 101 and the enterprise aspect input providing user can access questionnaire on a monitor associated with client computer 102 (FIG. 1), or vice versa. Alternatively, each user can access their respective questionnaire on either client computer 101 or 102, etc.

Once an answer input is made, the answer is stored by system 300, e.g., in database 106. Upon inputting an answer to the final question, window 700 can morph or otherwise change, link to another window, etc., to allow input providing users to review and edit their choices prior to final submission to system 300, wherein all finally selected answers to each question are submitted together. Screen buttons 799, 798, and 797 respectively allow the answers selected by the input providing user to be entered, cleared, or cancelled. Other functional buttons and/or other features can be provided by interactive window 700.

Each answer choice presented in answer fields 711-715 correspond to a certain information security risk level. The answers are arranged in fields 711-715 according to this risk level. In the exemplary implementation, the answers are arranged in fields 711-715 so that the highest risk answer (e.g., corresponding to the highest security risk) is presented in answer A field 711 and the lowest risk answer in answer E field 715, with fields 712-715 each presenting an answer of sequentially lower risk than the answer in the field immediately preceding it.

In another implementation, this answer choice risk ordering is reversed. In other implementations, the answer choice risk ordering can vary from question set to question set.

Each answer corresponding to fields 711-715 is weighted, e.g., with an assigned point value. A maximum point value, such as 100 points in the exemplary implementation, is set for each question set. In this implementation, question answers are listed, in descending order from the answer representative of the highest risk category to the answer representative of lowest risk category. Answer point values are assigned as tabulated in Table 1, below.

TABLE 1

| Question Answer | Weight Value |
|---|---|
| A | 10 |
| B | 8.4 |
| C | 6.4 |
| D | 3.4 |
| E | 1 |

Thus, were all ten answer choices to correspond to Answer A, the maximum point value (100 per questionnaire) would be reached. In the present implementation, the minimum sum of the answers in any aspect category is 10 (e.g., ten E answers times one point value, each).

Where an input providing user's answer selections, in any aspect category, sum to a value from 0-14 (10 the actual minimum in the present implementation), that questionnaire is ascribing a low risk, from the perspective of that aspect. Where the answers sum to a value between 15 and 34, an intermediate risk is ascribed. Moderate aspect category risks are identified by scores summing to a value between 35 and 64. High aspect category risks are identified by scores summing to a value between 65 and 84. Severe aspect category risks are identified by scores summing to a value from 85-100.

In one embodiment, answer weights are generated by taking the highest number from the range for each risk category (e.g., 14 for low, 34 for intermediate, 64 for moderate, 84 for high, and 100 for severe) and dividing by the number of questions (e.g., 10 in the present embodiment). The quotient thereof is adopted as the weight for the questions in that risk category.

In the present exemplary implementation, the range for a high risk spans values from 65 through 84, inclusive and there are ten questions. The weight for answers to questions in this high risk range thus corresponds to 84/10, which is equal to 8.4. Where implemented such that answer selection ‘b’ “always” corresponds to the high risk answers. In an exemplary situation wherein an input providing user selects the answer ‘b’ for every question, e.g., for each of ten questions, they would sum to the value of 10 times 8.4, for a product equal to 84, which lands the user's input relating to the project at the top of the high risk category. However, the present implementation uses a “midpoint value” of one (1) for answers in the low category, to render a low risk determination arithmetically possible, where effectively desired by the input providing user.

Exemplary Questions—Technical Exploit Risk Aspect

Questions relating to the technical aspect are designed to probe the risk of exploitation, compromise, etc. associated with an enterprise activity from a technical perspective, e.g., from an Information Security perspective relating to, e.g., computing, networking, etc. Ten exemplary such questions are numbered below in Table 2, with their respective answer choices alphabetically arranged thereunder according to the associated weight they each reflect. Questions other than those presented in Table 2 can be asked in various implementations. Table 2 is exemplary and not meant to be construed as limiting. As used herein, the term “blackhat” refers to a person or entity posing a real, significant, etc. threat to a business or other enterprise, to networks associated therewith, to data, operational processes, etc.

TABLE 2

| Question | | Answer choices: | |
|---|---|---|---|
| 1. | Where will this application be housed? | a) | Offsite with an Application Service Provider (ASP′); |
| | | b) | Internet Facing on Non-standard architecture; |
| | | c) | Internet Facing on Standard architecture, approved by an enterprise |
| | | | Information Security entity; |
| | | d) | Exclusively internal on Non-standard architecture; or |
| | | e) | Exclusively Internal. |
| 2. | How compliant is the application with relevant policies? | a) | Significant non-compliance with relevant policies; |
| | | b) | Some non-compliance with relevant policies; |
| | | c) | Generally compliant with relevant policies; |
| | | d) | Generally exceeds relevant policies; or |
| | | e) | Significantly exceed relevant policies. |
| 3. | Are there known vulnerabilities in the application or | a) | Significant vulnerabilities are known to exist and are being exploited, e.g., by |
| | associated infrastructure? | | black hats or other entities hostile to the enterprise; |
| | | b) | Significant vulnerabilities are known or suspected to exist, but such |
| | | | vulnerabilities are not being actively exploited; |
| | | c) | Vulnerabilities that are more difficult to exploit or are generally minor in nature |
| | | | are known to exist and are actively being exploited; |
| | | d) | Vulnerabilities that are more difficult to exploit or are generally minor in |
| | | | nature are known to exist, but are not being actively exploited; or |
| | | e) | No vulnerabilities are known to exist. |
| 4. | Are mitigation or workaround and/or other hardening | a) | The hardening status of the infrastructure is unknown; |
| | techniques implemented to minimize the risks and/or | b) | Infrastructure is not hardened and is in a largely default configuration; |
| | vulnerabilities inherent in the infrastructure? | c) | Infrastructure is hardened against certain attacks, but other vulnerabilities or |
| | | | risks remain unaddressed; |
| | | d) | Infrastructure is hardened to a high degree but has not been audited to verify |
| | | | compliance with hardening claims; or |
| | | e) | Infrastructure is hardened to a high degree and has been audited to verify |
| | | | compliance with hardening claims. |
| 5. | How interdependent is this application with other | a) | The level of dependency on other resources is unknown; |
| | resources? | b) | This application interacts with other applications or resources for basic |
| | | | functionality; |
| | | c) | This application interacts somewhat with other applications or resources; |
| | | d) | This application provides functionality to allow integration with other |
| | | | resources (such as APIs), but they are not used at this time; or |
| | | e) | This application is completely standalone, and does not interact with any other |
| | | | application or resource. |
| 6. | To what degree do you suspect deployment of this project | a) | It would significantly increase the risk for other systems or resources; |
| | in its current form would increase the security risk to | b) | It would somewhat increase the risk for other systems or resources; |
| | other systems, applications, resources, or projects in | c) | It might significantly increase the risk for other systems or resources; |
| | the event of a successful compromise? | d) | It might somewhat increase the risk for other systems or resources; or |
| | | e) | It most likely would not increase the risk for other systems or resources. |
| 7. | How is entitlement accomplished? | a) | A third party (such as an ASP′) who maintains an entitlement system outside |
| | | | the control of the enterprise (e.g., business, etc.); |
| | | b) | The infrastructure uses its own entitlement system that does not necessarily |
| | | | comply with relevant Information Security entitlement standards and policies; |
| | | c) | The infrastructure uses its own entitlement system that substantially complies |
| | | | with all relevant Information Security entitlement standards and policies; |
| | | d) | The infrastructure uses exclusively enterprise standard entitlement systems that |
| | | | comply in all significant respects with all relevant entitlement standards |
| | | | and policies; or Entitlement is not required for this application. |
| 8. | What is the disaster recovery (DR) status of this | a) | DR environment does not exist, but probably should; |
| | application? | b) | Some backup processes may exist, but architecture generally does not appear to |
| | | | be redundant; |
| | | c) | DR environment does exist, but is not approved by the enterprise's IT DR; |
| | | d) | DR environment does exist, and is approved by the enterprise's IT DR; or |
| | | e) | DR environment not required by this application. |
| 9. | What is the projected go-live date of this project from the | a) | Project has already gone live; |
| | time when enterprise Information Security was first engaged? | b) | Within the month; |
| | | c) | 2-4 months; |
| | | d) | 4-6 months; or |
| | | e) | 6+ months. |
| 10. | Who has developed this application? | a) | An external vendor who developed this application specifically for the |
| | | | enterprise, or an ASP′ developed application; |
| | | b) | Commercial Off-The-Shelf (COTS) without security documentation and |
| | | | patching; |
| | | c) | COTS-standard off-the-shelf applications and technologies (e.g., Windows ™) |
| | | | with security documentation and patching provided; |
| | | d) | Internally developed without source code security review; or |
| | | e) | Internally developed with source code security review. |

Exemplary Questions Business/Enterprise Risk Aspect

Questions relating to the business aspect are designed to probe the risk that exploitation, compromise, etc. would pose from the perspective associated with conducting enterprise activity, doing business, managing costs, financial risks, and liabilities, etc. Although the term “business” is used herein, it should be understood that the risk aspect being discussed is that which effects the operation of any enterprise or activity, be it a business, a government or military related enterprise, activity, operation, etc.

Ten exemplary such questions are numbered below in Table 3, with their respective answer choices alphabetically arranged thereunder according to the associated weight they each reflect. Questions relating to the business (and/or those relating to technical or other aspects) can pose hints, to guide the input providing user's thought process in relation to answering the hinting question. Similarly, questions presenting values, quantities, and the like for the input providing user's consideration in selecting an answer can vary, and questions other than those presented in Table 3 can be asked. Some questions can be presented as demands, requests, etc. to provide a rating, etc. Table 3 is exemplary and not meant to be construed as limiting.

TABLE 3

| | |
|---|---|
| Question | Answer choices: |

| | | | |
|---|---|---|---|
| 1. | Based on the business' information classification policy, | a) | Corresponds to the highest business security classification (e.g., ‘Secret’ in |
| | how would you classify the sensitivity of your data? | | some business enterprises, ‘Top Secret’ in U.S. government, military, etc.); |
| | | b) | Corresponds to the next highest business security classification (e.g., ‘Highly |
| | | | Confidential’ in some enterprises, ‘Secret’ in U.S. government, military, etc.); |
| | | c) | Corresponds to the most middle level business security classification (e.g., |
| | | | ‘Restricted’ in some enterprises and in some U.S. government, military, etc. |
| | | | usage); |
| | | d) | Corresponds to the lowest (e.g., yet not unclassified, unrestricted, etc.) |
| | | | business security classification (e.g., ‘Confidential’ in some business |
| | | | enterprises and U.S. government, military, etc.); or |
| | | e) | Corresponds to effectively public (e.g., having an unclassified, unrestricted, |
| | | | etc. business security status). |
| 2. | What is the total Dollar (USD) value (or equivalent value | a) | >100 Million USD; |
| | expressed in another relevant currency, exchange value | b) | 50 Million-100 Million USD; |
| | system status, etc.) of the project and the project's | c) | 1 Million-50 Million USD; |
| | data? | d) | 500,000-1 Million USD; or |
| | HINT: One valid way to estimate this value, e.g., in selecting | e) | ≦500,000 USD. [Note: an exemplary Hint is included with this |
| | the answer choices below, is to determine, estimate, calculate, | | question.] |
| | etc. how much the project will cost the business to | | |
| | implement. This project is effectively worth at least that | | |
| | much. | | |
| 3. | What would you estimate the Dollar (USD) damage to the | a) | >100 Million USD; |
| | business would comprise, were the data stolen, destroyed, | b) | 50 Million-100 Million USD; |
| | subject to unauthorized modification, and/or | c) | 1 Million-50 Million USD; |
| | subject to unauthorized disclosure, etc.? | d) | 500,000-1 Million USD; or |
| | | e) | ≦500,000 USD. |
| 4. | What is the value of this application to the business? For | a) | >100 Million USD; |
| | instance, how much money will save and/or bring in to the | b) | 50 Million-100 Million USD; |
| | business in a fiscal year, what is its annual revenue | c) | 1 Million-50 Million USD; |
| | generating prospect, etc.? | d) | 500,000-1 Million USD; or |
| | | e) | ≦500,000 USD. |
| 5. | What important business systems would be impacted with | a) | Critical financial systems, critical manufacturing, critical customer support, |
| | the failure of this application? | | and/or other critical systems, etc.; |
| | | b) | Non-mission critical financial, manufacturing, or customer support |
| | | | applications; |
| | | c) | General business applications; |
| | | d) | Education, training applications, etc.; or |
| | | e) | None of the above. |
| 6. | Who is the primary audience, user base, etc. for this | a) | Senior level executives and/or high level financial personnel or large customer |
| | application? | | base; |
| | | b) | Business customers or resellers, or external business partners; |
| | | c) | Targeted internal business audience (e.g., a particular group, department, etc. |
| | | | within a business); |
| | | d) | General business employees/personnel, etc.; or |
| | | e) | General public. |
| 7. | Does this project deal with any of the following personally | a) | Credit/debit card information and purchase orders; |
| | identifying information (e.g., does it involve any significant | b) | Business human resources (HR) related information, such as salary, Social |
| | privacy issues)? | | Security Number, or other private person-centered data, etc.; |
| | | c) | HR contact information such as addresses, phone numbers, directory |
| | | | information, etc.; |
| | | d) | Personal information regarding non-business persons, such as customer lists, |
| | | | contact information, etc.; or |
| | | e) | No information that would pose a significant privacy concern. |
| 8. | What development stage is the project in right now? | a) | Technical and business solution is designed and resources have been |
| | | | purchased, contracts have been signed, etc. |
| | | b) | Business solution and Technical solution designed but no resources have been |
| | | | assigned; |
| | | c) | Business solution already designed but no resources have yet been purchased |
| | | | or otherwise procured and No Technical solution has yet been designed; |
| | | d) | Project team is currently designing a business solution; or |
| | | e) | In preliminary phase; No design work yet started. |
| 9. | Rate the criticality of this application for/to the continuing | | Severe impact - Mission critical and no workaround if the application |
| | operation of the business' enterprises, operations, activity, | | goes down (e.g., fails, etc.); |
| | etc.; e.g., what would the impact be to the business of a | | High impact - Mission critical, but there are temporary |
| | failure of this application? | | workarounds in case the application goes down; |
| | | | Moderate impact - Not mission critical; downtime of a day or |
| | | | so is tolerable; |
| | | | Intermediate impact - Loss (e.g., failure, etc.) of the |
| | | | application may cause some disruption to business |
| | | | activity, operations, etc., but most functions continue; or |
| | | | Low impact - Loss of the application may go unnoticed by |
| | | | the business for significant periods of time (e.g., |
| | | | application loss typically goes unnoticed for days, etc.). |
| 10. | Disruption of this application would have what sort of | a) | Directly impact existing customer environments and/or ability to get customer |
| | effect on customers of the business? | | support; |
| | | b) | Impact customer order placing capabilities; |
| | | c) | Impact the ability to receive time sensitive information; |
| | | d) | Impact the ability for customers to receive general information regarding the |
| | | | enterprise; or |
| | | e) | Impact the ability for potential customers to receive promotional information. |

FIG. 7 depicts an exemplary logic assessment module 303, according to an embodiment of the present invention. Logic assessment module 303 receives input from completed questionnaires. This input is provided to a risk processor 805. Business risk evaluator 816 therein evaluates inputs relating to the enterprise aspect. Technical exploit risk evaluator 817 evaluates inputs relating to the technical aspect.

Aspect combining calculator 821 performs a computer implemented and/or network based process wherein the respective enterprise aspect related and technical aspect related inputs (with input relating to any other aspect) are combined arithmetically (e.g., summed). The sum is divided by the number of aspect related inputs (e.g., 2) to calculate a quotient representative of the relevant composite (e.g., combined, total, average, etc.) information security risk. This composite risk quotient is rendered available to system 300 (FIG. 3) with a risk publisher 839.

Logic assessment module 303, in one embodiment, performs a computer based process to provide a risk based output corresponding to the questionnaire inputs. Where Bwₙ refers to the weighted enterprise (e.g., Business) risk associated with each corresponding question, n is the question number, and m is the highest cardinal question number, aspect combining calculator 821 calculates the enterprise risk R₁ generally according to:
R₁=Bw₁+Bw₂+Bw₃+ . . . +Bwₘ (Equation 1).
In the present implementation, m=10, thus:
R₁=Bw₁+Bw₂+Bw₃+ . . . +Bw₁₀ (Equation 2).

Where TBwₙ refers to the weighted technical exploit risk associated with each corresponding question, n is the question number, and m is the highest cardinal question number, aspect combining calculator 821 calculates the enterprise risk R₂ generally according to:
R₂=Tw₁+Tw₂+Tw₃+ . . . +Twₘ (Equation 3).
In the present implementation, m=10, thus:
R₂=Tw₁+Tw₂+Tw₃+ . . .+Tw₁₀ (Equation 4).

With results R₁ and R₂, where k is the highest cardinal number of aspects for which risk inputs were received with interactive questionnaire answers, aspect combining calculator 821 calculates a composite risk R_{C}, generally according to:
R_{C}=(R₁+R₂+ . . . +Rₖ)/k (Equation 5).
In the present implementation, k=2, for each of the technical exploit and business aspect questionnaires; thus:
R_{C}=(R₁+R₂)/2 (Equation 6).

In the present implementation, n=10 and k=2. However, in other implementations, any number of questions can be used on the questionnaires, and any number of aspect questionnaires can be used to consider the risks relating to as many aspects. Embodiments of the present invention provide the advantage of elegant simplicity in the calculation of risks such as the enterprise risk, the technical risk, and the composite risk, as seen with reference to equations 1-6 above.

Process modifier 803 allows the process performed with risk processor 805 to be modified (e.g., updated, corrected, calibrated, etc.). Scale adjuster 802 provides a modification process for constants (e.g., algorithm, etc.), such that they can be adjusted or changed over time, circumstance, and/or paradigm, etc. In the exemplary implementation, results are not disclosed to the enterprise until an enterprise Information Security representative (e.g., employee, etc.) reviews and approves the results.

Output engine 801 provides a risk assessment (e.g., model) based on analysis of the input questionnaires. A screen output generator 811 makes the results available on a monitor. Output engine 801 categorizes risks based on the calculated composite risk R_{C}. This composite risk is categorized according to Table 4, below.

TABLE 4

| Risk Category | R_{C} | Color |
|---|---|---|
| Low | 0-14 | Green |
| Intermediate | 15-34 | Blue |
| Moderate | 35-64 | Yellow |
| High | 64-84 | Orange |
| Severe | 85-100 | Red |

In the present implementation, practically speaking, the composite risk will not be less than 10, because each low risk answer in each category is weighted with a value of one (1). Screen output generator displays the severity of the risk category and other results of the risk modeling using colors, as discussed above, in the present implementation. Other color schemes and category severity indicators can be used in other implementations. The results therein will also define each risk category, what it means in context of the other risk categories, and give advice as to appropriate actions for an application in a specific risk category.

A Low risk level from a technical perspective corresponds to applications that are relatively very secure and are appropriate for making externally visible. From an business/enterprise perspective, low risk level corresponds to applications, projects, etc. wherein the business damage thereto caused by compromise thereof can be considered very slight to negligible. Such risks can be characterized (e.g., represented graphically on a monitor, etc.) with a color or similar indicator. In the case of a low risk level, such risks are represented graphically (e.g., by text, field background, etc.) in the present implementation by a color such as green.

An Intermediate risk level from a technical perspective corresponds to applications that are more vulnerable than low risk applications. Such a risk however is still relatively minor, from a technical and an business aspect. From the perspective of a technical aspect (e.g., from a technical perspective), such applications are appropriate to make externally visible. From the perspective of an business/enterprise aspect, such applications are appropriate to outsource. An intermediate risk level is represented graphically in the present implementation by a color such as blue.

A Moderate risk level from a technical perspective corresponds to applications wherein technical security means, techniques, procedures, methods, precautions, etc. may not be adequate in the light of the exploitation, exposure, or other risk posed. Caution would be deemed prudent when allowing exposure of such applications, e.g., to the Internet, or placing them on the sometimes so-called De-Militarized Zone (DMZ), a subnet between the trusted internal network of the enterprise (e.g., the firewalls thereof) and an external network, such as the Internet.

From an business/enterprise perspective, moderate risk level applications have significant possible consequences, such as financial loss, liability, etc. Such risks can be characterized (e.g., represented graphically on a monitor, etc.) with a color or similar indicator. Moderate risk level is represented graphically in the present implementation by a color such as yellow.

A High risk level application have both substantial value to the enterprise (e.g., business value) and substantial technical vulnerability. The failure of such an application can directly impact the bottom line of a business or another enterprise. From a technical perspective, such applications should not be exposed to the Internet. From a business perspective, such applications should not be outsourced, e.g., to a third party without, extraordinary scrutiny directed towards related security measures available from that third party. High risk level is represented graphically in the present implementation by a color such as orange.

Severe risk level applications are critical to the enterprise and substantial technical vulnerability. Compromise or the failure of such an application will most likely have a significant impact on the bottom line of a business or other enterprise. From a technical perspective, such applications must not face the Internet. From a business perspective, such applications must not be outsourced, e.g., to a third party. Going live (e.g., being used in a production capacity and/or supporting business operations, etc., in contrast for instance to a development environment, wherein application testing and validation is performed, prior to the application's use for business operations), from any perspective, requires the approval of a very senior executive, such as a vice president in a business or civil government enterprise, a flag or general officer in a military based enterprise, etc. Severe risk level is represented graphically in the present implementation by a color such as red.

In the exemplary implementation, security risks associated with technical aspects are assumptively of equal significance, importance, etc., as security risks associated with business aspects. Thus, the various aspects share equity in weighting and scoring of their respective answers. In another implementation, the respective weighting and scoring of each aspect can be adjusted relative to that of the other aspect.

In the exemplary implementation, it is assumed that a population distribution of various enterprise IT activities, each having its own associated characteristic security risk, will be roughly normal. Thus, most projects will assumptively fall in the moderate risk category. The next largest risk number of population groups fall into the intermediate and the high categories and the lowest are at the risk extremes: severe and low.

For instance, risk questions in the present implementation have weighted answers that an input providing selects, through deductive and inductive reasoning, etc., to ascribe (e.g., assign, relate, recognize, etc.) a value to the risk inherent in a particular activity, as based on that user's experience, training, education, intuition, and perspective.

Where a technical exploitation risk is high, for instance, where R₁ is 90, and business risk is also high, for instance, where R₂ is also 90, the composite risk R_{C} would be 90; also high. Where a technical exploitation risk is low, for instance, where R₁ is 20, and business risk is also low, for instance, where R₂ is also 20, the composite risk R_{C} would be 20; also low. However, where a technical exploitation risk is high, for instance, where R₁ is 90, but the business risk is low, for instance, where R₂ is 20, the composite risk R_{C} would be 55, which is intermediate. Likewise, where a technical exploitation risk is low, for instance, where R₁ is 20, but the business risk is high, for instance, where R₂ is 90, the composite risk R_{C} would also be an intermediate 55. Advantageously therefore, the multidimensional vectored approach described herein is uniquely powerful in its ability to balance out all aspects of concern relating to security, rather than a single risk aspect. Such balancing explains the risk levels and what they mean in relationship to each other.

A database output generator 812 stores the results. A search engine 804 provides search capability for a user of risk processor 303.

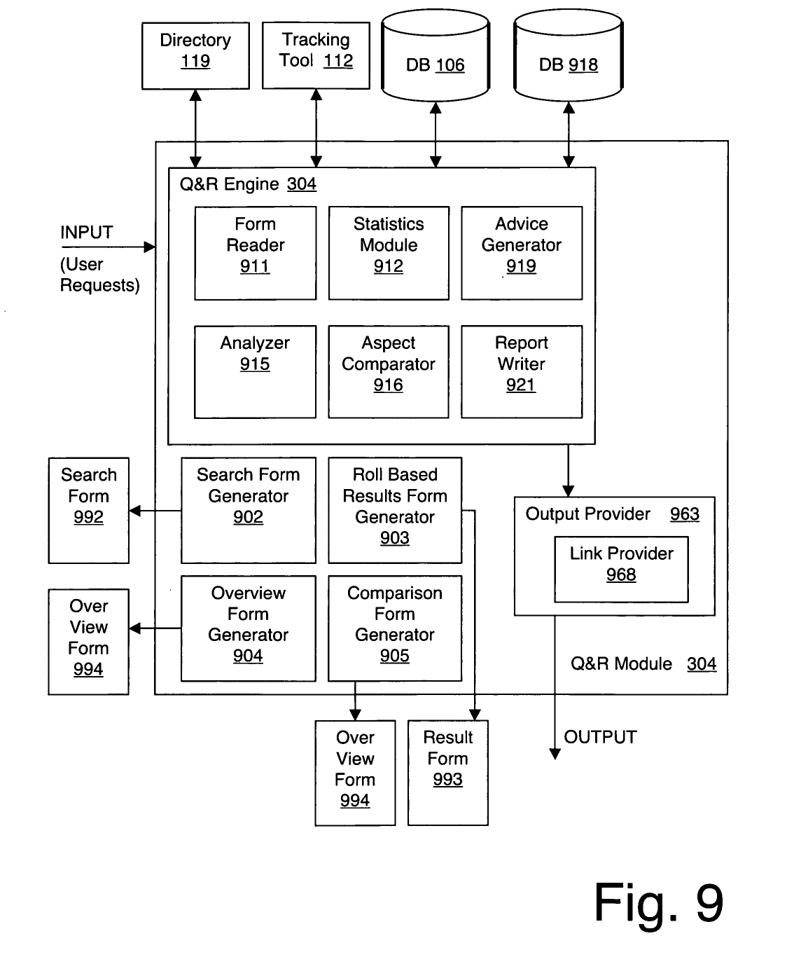

FIG. 9 depicts an exemplary query and reporting module 304, according to an embodiment of the present invention. Query and reporting (Q&R) module 304 handles queries put to system 300 by a querying user relating to, e.g., role based results of risk modeling with analysis thereof and generating corresponding guidance providing reports responsive to that user's request.

A Q&R engine 901, in response to a querying user request, generates a variety of interactive search forms, which can be web pages. A querying user interacts with Q&R engine 901 with these forms. In the present embodiment, Q&R engine 901 generates forms 992-995 with corresponding form generators 902-905. In other embodiments, the forms are generated by Q&R engine 901 without form generators distinct therefrom, with a different number of generators from those shown herein, e.g., with functions of some shown herein subsumed by others also so shown, etc.

A search form generator 902 generates an interactive search form 992 with which the querying user can perform a search. A role based results form generator 903 generates an interactive role based results form 993 with which the querying user can access, select, input, and analyze role based results. An overview search form generator 904 generates an interactive overview form 994 with which a querying user can access, select, input, and analyze statistical and/or other information relating to risk modeling projects that are entered into system 300. A comparison form generator 905 generates an interactive comparison form 995 with which a querying user can display different risk analyses of a risk modeling project, for instance, for a before and after or another comparison. Forms 992-995 comprise GUI windows in one implementation.

Q&R engine 901 accesses database 106, tracking tool 112 and directory 119 for various information, and in one embodiment, has its own database 918. Q&R engine 901 reads, integrates, and/or controls generation of forms 993-995 with a form reader 911. Information provided to Q&R engine 901 is analyzed by analyzer 915 with an aspect and role comparator 916, which provide input to an advice generator 919. Advice generated therewith is rendered in a presentable report format (e.g., text, statistics, graphics including colors, etc.). Output provider 963 provides query results to a querying user, such as by providing a link (e.g., hyperlink) to the project, e.g., with tracking tool 112 and can access contact data with directory 119.

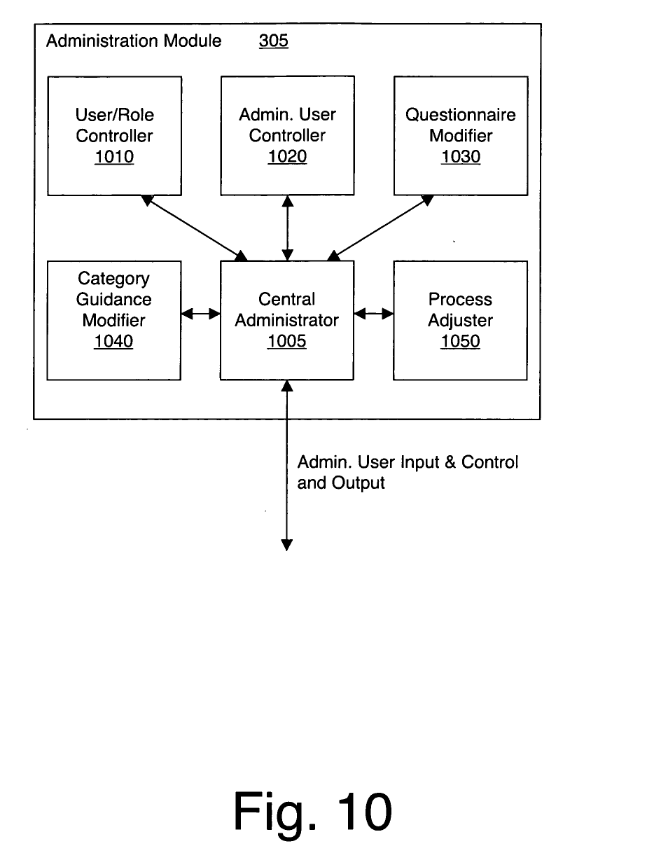

FIG. 10 depicts an exemplary administrative module 305, according to an embodiment of the present invention. A central administrator 1005 responds to the input and control of an administrative user. A user and role controller 1010 allows an administrative user to add, modify, delete input providing and other users and roles. An administrative user controller 1020 allows creation, authorization, etc. of new administrative users.

A questionnaire modifier 1030 allows administrative users to modify questions within questionnaires, add new questions to and delete questions from the questionnaires, and/or add new and/or modify existing questionnaires. A category (e.g., aspect) guidance modifier 1040 allows an administrative user to change the standard guidance rendered in response to queries, etc. relating to aspect based and/or composite results. Process adjuster 1050 allows the role modeling process to be adjusted, modified, changed, etc., such as by modifying variables used by process controlling algorithms, etc.

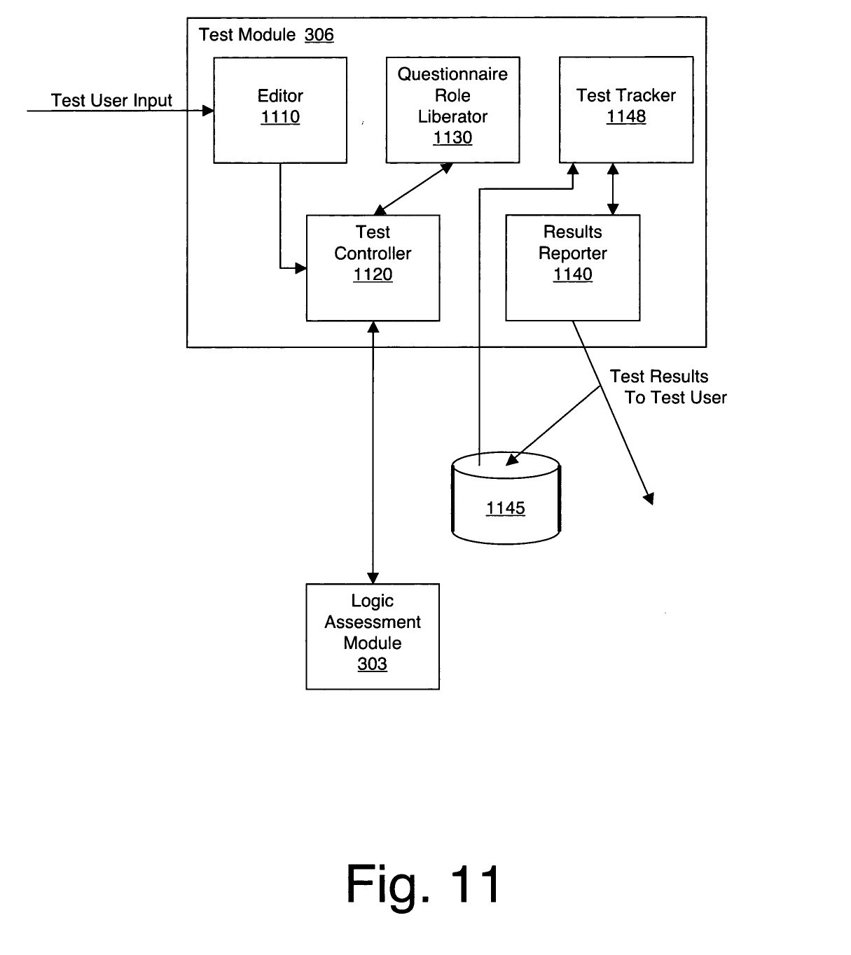

FIG. 11 depicts an exemplary test module 306, according to an embodiment of the present invention. Test module 306 allows risk prototyping, fast analysis of hypothetical information security related scenarios, testing of proposed assumption changes, etc. in response to a test user's input. An editor 1110 passes the test user's input to test controller 1120. Editor 1110 allows no entry of specific project information.

Questionnaire role liberator 1130 allows the test user, who may in one implementation be an authorized technical aspect input providing user, to answer all questions for all aspects, e.g., for the enterprise aspect as well as the technical aspect. Thus, test input corresponding to hypothetical security scenarios to be examined, analyzed, considered, etc. can be provided by the same questionnaires used for risk modeling. Tests can be effectively, quickly, and inexpensively repeated, e.g., re-answered and re-run.

Results reporter 1140 provides the test results to the test user, e.g., graphically on a monitor, which can allow the user to operate the test module with a GUI, e.g., for completing and submitting the questionnaires. Results reporter 1140 can write test results to a database or other storage, memory, etc. 1145, associated and/or dedicated, etc. to the test module. However, in some implementations, test results are not written to database 106, which conserves storage and network resources. Report tracker 1148 keeps track of tests, scenarios, results, etc.

In one embodiment, input providing users perform roles according to the aspect for which their input is relevant. For instance, in the present implementation, the roles played by two input providing users are performed one according to an enterprise related aspect and the other according to the technical aspect. Inputs related to the enterprise aspect are provide by a business user, who performs the enterprise, e.g., business related role. Inputs related to the technical aspect are provided by a technical, e.g., informational security (InfoSec) expert, who performs the InfoSec role.

The business role comprises considering, completing, and submitting the enterprise aspect questionnaire. Business users log in (e.g., on) to system 300, e.g., with methods known in the art. Their login is transparent. They are prompted for a user name and password when they click a link (e.g., hyperlink) to, or otherwise access a Uniform Resource Locator (URL) of a document such as a web page, which is provided to them, e.g., via email. In the present implementation, business users do not log in directly to web based application 21. Their role is assigned after processing their user name and password.

Upon successful login, business users are accorded access to their questionnaires for their specifically assigned project, which they can consider, complete, modify, and submit. Upon submission of their completed questionnaire and approval, by an InfoSec authority, of disclosure of that project's results, e.g., to the business user, business users can view, composite risk results for that project using Q&R module 304.

The InfoSec role comprises considering, completing, and submitting the technical aspect questionnaire. The InfoSec user goes directly to a web page functioning as the homepage for web based application 21. Upon accessing the homepage, the InfoSec user is authenticated against an access list maintained (e.g., stored, secured, updated, validated, audited, etc.) with authenticator 122. Upon authentication, the InfoSec user's role is identified and options (e.g., accessing their questionnaire for providing input to web based application 21, etc.) are presented according to that role.

In addition to their role as technical aspect input provider, e.g., with their corresponding questionnaire, InfoSec users can also access project creation module 301 to create risk model projects. Upon project creation, the InfoSec user inputs email addresses and/or other identifiers of the project team members, who are then granted exclusive authorization to view that project (e.g., also with other InfoSec users for other functions).

InfoSec users can also access assessment module 303 to run an assessment on a project assigned to that user, and to Q&R module 304 for queries and reports on any and/or all projects within web based application 21. Select InfoSec users, e.g., those with authority granted by enterprise management, etc., can access administrative module 305. Any and/or all InfoSec users can also routinely access test module 306.

Exemplary Process

FIG. 12 is a flowchart of an exemplary computer implemented process 1200 for modeling real-world information security risk, according to an embodiment of the present invention. In one embodiment, system 300 comprises means for performing process 1200. Process 1200 begins with step 1201, wherein a risk modeling project is created.

In step 1202, appropriate questionnaires are prepared, one corresponding to a technical exploit aspect and another to the business related aspect of the project. In step 1203, links to their respectively appropriate questionnaires are provided, e.g., via email, to the InfoSec and the business input providing users.

Upon each user providing their respective input (e.g., accessing, considering, completing, and submitting their respective questionnaires), in step 1204, the inputs are processed wherein risk assessment is performed. In one embodiment, risk assessment comprises several component steps, for instance, calculating and categorizing the two individual aspect related risks. Calculating can also comprise several component steps.

Thus, in step 1205, a risk (e.g., R₁) corresponding to business related aspects is calculated. In step 1206, a score for each answer provided on the business aspect questionnaire is weighted. In step 1207 the weighted scores are summed. In step 1208, the magnitude of the sum is evaluated. In step 1209, on the basis of this evaluation, the business aspect risk score s calculated . In step 1210, the business aspect score sum is processed with other information, e.g., data corresponding to a technical aspect of the risk.

In step 1211, a risk (e.g., R₂) corresponding to technical exploit aspects is calculated. In step 1212, a score for each answer provided on the technical exploit aspect questionnaire is weighted. In step 1213 the weighted scores are summed. In step 1214, the magnitude of the sum is evaluated. In step 1215, on the basis of this evaluation, the technical exploit aspect risk score is calculated . Steps 1205 and 1211 can be performed in any order. In step 1210, the technical aspect score sum is processed with the business aspect score sum.

In one embodiment, step 1210 comprises several component steps, which effectively calculate a composite risk (e.g., R_{C}). In step 1216, the individual aspect risks (e.g., R₁ and R₂; other individual aspect risk elements can be used, as well) are summed. In step 1217, the sum of the individual aspect risks is divided by the number of aspect categories wherein the resulting quotient comprises the composite risk.

In step 1218, the magnitude of the composite risk is evaluated. On the basis of this evaluation, in step 1219, the composite risk is categorized. In step 1220, a standard (e.g., pre-stored) guidance relating to the evaluated risk category is accessed. In step 1221 an output is provided, completing process 1200. The output comprises, in one embodiment, the composite risk is provided with corresponding standard guidance and the individually categorized component individual aspect related risks.

The present embodiment thus considers information security risk from a number different dimensions. Scoring the information input, such as weighting a series of answers provided on a questionnaire relating to that aspect, provides a magnitude of risk in that particular dimension, which are combined to calculate the composite information security risk. The present embodiment therefore provides a multi-vectored approach to modeling an information security risk, the input in each individual aspect comprising a separate vector.

In one embodiment, process 1200 is provided as a service within an enterprise to allow InfoSec experts and executives to evaluate information security risks such as liability for damages resulting from system, network, data, and/or application compromise, threats to revenue, threats of loss and/or damage to assets, and the like. Further, such services can be provided to other enterprises to derive a benefit therefrom, on for instance a subscription, pay per use, service agreement, promotional, and/or other basis, using e.g., automatic billing. Thus, process 1200 comprises a useful and powerful business method relating to the growing demand for information security.

In summary, embodiments of the present invention provide a system and method for modeling information security risk to an enterprise. In one embodiment, the method includes providing multiple input media, each of which forms a vector of risk severity in a dimension characterizing the information security risk. Each vector is of a dimension distinct from that of each other vector. The input media are user interactive for providing input to a computer. The input includes data corresponding to the magnitude and dimension of each of the vectors. Upon receiving the input, the vectors are processed to output a model of the information security risk. In one embodiment, each risk is modeled from the perspective of at least two dimensions, one related to a technical exploit aspect of the risk, and the other related to a risk aspect associated with the business. In one embodiment, the input media could be a web based application.

Thus, a system and method for modeling information security risk to an enterprise are described. While the present invention has been described with reference to particular embodiments, it is to be appreciated that the present invention is not be construed as limited by such embodiments, but rather construed according to the following claims and their equivalents.

What is claimed is:

1. A system for modeling a risk to an enterprise activity relating to information security, comprising:
a web based application having access to a network;
a questionnaire module functioning with said web based application for providing a plurality of sets of questions wherein sets of said plurality relate to different aspects of said information security risk and wherein one of said sets of questions relates to a technical exploit aspect and one of said sets of questions relates to business associated aspect; and
a logic assessment module functioning with said web based application for processing an input from said questionnaire module and providing an appropriate corresponding output comprising a model of said information security risk.

2. The network based system as recited in claim 1 further comprising a database accessible with said network, for storing said output and said plurality of sets of questions.

3. The network based system as recited in claim 1 wherein said processing comprises:
calculating a component of said information security risk relating to said technical exploit aspect;
calculating a component of said information security risk relating to said business associated aspect; and
combining said technical aspect related component with said business aspect associated aspect component and dividing by two (2) wherein the resulting quotient corresponds to a composite information security risk.

4. The network based system as recited in claim 3 wherein said processing further comprises:
evaluating the magnitude of said composite information security risk; and
categorizing said composite information security risk on the basis of said evaluating.

5. The network based system as recited in claim 3 wherein one said questionnaire relates to another aspect and wherein said processing further comprises:
calculating a component of said information security risk relating to said other aspect; and
combining said technical aspect related component, said enterprise associated aspect component, and said other component and dividing by a number equal to the total number of aspects, wherein the resulting quotient. corresponds to a composite information security risk.

6. The network based system as recited in claim 1 further comprising a graphical user interface functioning with said web based application wherein said providing a plurality of questionnaires comprises:
generating said plurality of sets of questions wherein each sets of questions of said plurality of questionnaires is rendered as a interactive web page; and
sending a link for accessing each said set of questions of said plurality of sets of questions to a different input providing user.

7. The network based system as recited in claim 6 wherein said sending a link comprises emailing said link.

8. The network based system as recited in claim 1 further comprising a tracking tool accessible with said network for tracking projects relating to said web based application.

9. The network based system as recited in claim 8 further comprising a project creation module functioning with said web based application and said tracking tool for originating a project modeling said risk to said enterprise activity.

10. The network based system as recited in claim 8 further comprising a query and reporting module functioning with said web based application and said tracking tool for accessing said output, indicating statistical information relating to said project, and displaying a risk analysis relating to said project and based on said output, wherein said output further comprises standard guidance based on said model and wherein said standard guidance is generated, selectively, with said query and reporting module and said logic assessment module.

11. The network based system as recited in claim 10 further comprising an administrative module functioning with said web based application for modifying said sets of questions, for modifying said processing, and for modifying said standard guidance.

12. The network based system as recited in claim 1 further comprising a test module functional with said web based application for running a rapid risk prototyping test.

13. The network based system as recited in claim 1 wherein said network based system comprises a web environment supporting one or more of Java, PERL, PHP, and C.

14. A network based computer implemented method for modeling risk to a business activity relating to the information security thereof, comprising:
providing a plurality of input media wherein each input medium of said plurality comprises a vector of risk severity in a dimension characterizing said information security risk wherein the said dimensions of each said vector are distinct from each other and wherein said input media are user interactive for providing an input to a computer of said network, said input comprising data corresponding to the magnitude and dimension of each said vector; and
upon receiving said plurality of vectors, processing said plurality of vectors to output a model of said information security risk.

15. The network based computer implemented method as recited in claim 14 wherein one said dimension relates to a technical exploitation risk aspect of said information security risk and another said dimension relates to an aspect of said information security risk associated with said business activity.

16. The network based computer implemented method as recited in claim 14 wherein each said input medium comprises an interactive web page that is distinct from the web page of each other said input medium.

17. The network based computer implemented method as recited in claim 16 wherein each said input medium comprises a plurality of interactive sets of questions, each distinct from each other and each providing a user selectable plurality of distinct answer choices wherein each said answer choice of said plurality of answer choices has a different weight from each other answer choice.

18. The network based computer implemented method as recited in claim 17 wherein said providing a plurality of input media comprises:
sending to a user a link to one of said input media; and
upon said user accessing said link, sending to said user said one of said input media.

19. The network based computer implemented method as recited in claim 17 wherein said providing an input to said computer comprises said user selecting from among said answer choices to complete said set of questions and sending said completed set of questions to said computer.

20. The network based computer implemented method as recited in claim 17 wherein said processing said plurality of vectors comprises:
calculating a component of said information security risk related to each said dimension wherein said component comprises a sum of said answer choices, taking each said weight thereof into account; and
combining said components into a sum of said components; and
dividing said sum of said components with the number of said dimensions wherein the resulting quotient comprises a composite model of said information security risk.

21. The network based computer implemented method as recited in claim 20 wherein said processing further comprises:
evaluating the magnitude of said quotient; and
categorizing said quotient on the basis of said evaluating wherein said composite model further comprises a category corresponding to said quotient.

22. The network based computer implemented method as recited in claim 21 further comprising accessing standard advice corresponding to said category wherein said advice is provided, selectively, with said output and in response to a user request.

23. A computer based system functional in a network environment for modeling a risk to an enterprise activity relating to the information security thereof, comprising:
means for providing a plurality of input media wherein each input medium of said plurality comprises a vector of risk severity in a dimension characterizing said information security risk wherein the said dimensions of each said vector are distinct from each other and wherein said input media are user interactive for providing an input to a computer of said network, said input comprising data corresponding to the magnitude and dimension of each said vector; and
means for processing said plurality of vectors to output a model of said information security risk upon receiving said plurality of vectors.

24. A computer usable medium having a computer readable program code for causing a computer system functioning in a network environment to execute a method for modeling a risk to an enterprise activity relating to the information security thereof, comprising:
providing a plurality of input media wherein each input medium of said plurality comprises a vector of risk severity in a dimension characterizing said information security risk wherein the said dimensions of each said vector are distinct from each other and wherein said input media are user interactive for providing an input to a computer of said network, said input comprising data corresponding to the magnitude and dimension of each said vector; and
upon receiving said plurality of vectors, processing said plurality of vectors to output a model of said information security risk.

25. A network based computer controlled programming tool having a graphical user interface and comprising:
a first window for creating a project for modeling a risk to a business activity relating to the information security thereof wherein said creating comprises:
generating at least two (2) web page based sets of questions, one said set of questions relating to a technical exploitation aspect related to said information security risk and another said set of questions relating to an aspect associated with said business activity;
generating respective links to said sets of questions; and
emailing said respective links to at least two input providing users each respectively selected to access one of said pluralities;
a second window for allowing said input providing users to each answer one of said sets of questions wherein said second window presents each said set of questions as a plurality of sequential questions, each said question having a plurality of individually weighted answers, user selectable to provide said input; and
a retrieval and storage mechanism, for accessing questions comprising said web based questionnaires in response to said creating and storing said input.

26. A business method for providing a service for modeling relating to the information security risk of an activity of an enterprise, comprising:
providing a plurality of input media wherein each input medium of said plurality comprises a vector of risk severity in a dimension characterizing said information security risk wherein the said dimensions of each said vector are distinct from each other and wherein said input media are user interactive for providing an input to a computer of said network, said input comprising data corresponding to the magnitude and dimension of each said vector;
upon receiving said plurality of vectors, processing said plurality of vectors to output a model of said information security risk; and
deriving a benefit from said providing a service wherein said benefit comprises, selectively, revenue paid from said enterprise for said service and a promotional benefit.

27. The business method as recited in claim 26 wherein said revenue is paid on the basis of, selectively, a subscription, a payment per use, and payment according to a service agreement.
